(19) United States
(12) Patent Application Publication
(10) Pub. No.: US 2023/0386739 A1
(43) Pub. Date: Nov. 30, 2023

(54) COMPACT COUPLED INDUCTOR

(71) Applicant: TDK Electronics AG, München (DE)

(72) Inventors: Stefan WEBER, München (DE); Youli (Leo) YAO, Pleasanton, CA (US); Steve SISK, Gary, SD (US)

(73) Assignee: TDK Electronics AG, München (DE)

(21) Appl. No.: 18/248,891

(22) PCT Filed: Sep. 30, 2021
(86) PCT No.: PCT/EP2021/076937

§ 371 Date: Apr. 13, 2023

(30) Foreign Application Priority Data
Oct. 15, 2020 (DE) 102020127173.5

(51) Int. Cl. H01F 37/00; H01F 3/14; H01F 27/28

(52) U.S. Cl. CPC H01F 37/00; H01F 3/14; H01F 27/2828; H02M 3/1586

(57) ABSTRACT

A compact coupled inductor with improved properties is provided. The coupled inductor comprises a shared leg between a base and a top and two center legs between the base and the top and a first vertical gap in the first center leg and/or the second center leg.

### CROSS-REFERENCE TO RELATED APPLICATIONS

The present application is the national stage entry of International Patent Application No. PCT/EP2021/076937, filed on Sep. 30, 2021, and published as WO 2022/078769 A1 on Apr. 21, 2022, which claims the benefit of priority of German Patent Application No. 10 2020 127 173.5, filed on Oct. 15, 2020, the disclosures of all of which are incorporated by reference herein in their entireties.

### FIELD OF THE INVENTION

The present invention refers to the field of coupled inductors, specifically magnetically coupled inductors that may be used in voltage converters, e.g. in DC-DC converters.

### BACKGROUND OF THE INVENTION

DC-DC converters can be used to convert a first DC voltage level to a second DC voltage level. The second DC voltage level can be lower or higher than the first voltage level.

Typically, DC-DC voltage converters should be compatible with high power applications, should work with a high power efficiency and should have small spatial dimensions. A high power efficiency can be obtained by reducing losses such as core losses.

Further, the voltage ripple provided at the output port should be as small as possible.

From the U.S. Pat. No. 7,612,640 B2 and from the U.S. Pat. No. 6,362,986 B1 coupled inductors, for example for DC-DC converter applications, are known.

However, in addition to the above-cited objects, it is further desired to have converters with additionally improved characteristics. In particular, it would be desired to have converters based on improved magnetic properties of the magnetically active components of the converters.

To that end, a coupled inductor according to independent claim 1 is provided. Dependent claims provide preferred embodiments.

### SUMMARY OF THE INVENTION

The coupled inductor comprises a base and a top. Further, the coupled inductor comprises a shared leg between the base and the top, a first center leg between the base and the top and a second center leg between the base and the top. Additionally, the coupled inductor comprises a first vertical gap in the first center leg and/or a first gap in the second center leg. Further, the coupled inductor comprises a first coil and a second coil. The first coil is wound around the first center leg. The second coil is wound around the second center leg. The shared leg is arranged between the center legs.

The first coil and the second coil can be electrically connected or coupled to other circuit elements of the corresponding DC-DC converter. The corresponding center legs of the coupled inductor establish magnetic cores utilized for conducting magnetic flux associated with the corresponding coils.

At least parts of the base and of the top establish further flux conducting segments such that an improved magnetic flux conductance is provided. The center legs have their corresponding coil wound around the material of the center legs such that the center legs are essentially arranged in the center of the corresponding coil.

The shared leg establishes a magnetic flux conduction path that is available for flux associated with different coils. Thus, the corresponding conductance path is “shared” by different coils.

The base, the legs and the top of the coupled inductor are stacked such that the legs are arranged—in a vertical direction—on or above the base and the top is arranged—in a vertical direction—above the legs. The vertical direction is parallel to the Z axis and perpendicular to the X-Y plane.

The center legs and the shared leg are arranged one next to another on the base of the coupled inductor such that the shared leg is arranged—in a horizontal direction within the X-Y plane—between at least two center legs.

The described coupled inductor has its leakage inductance adjustable. Specifically, the leakage inductance can be adjusted by the spatial dimensions of the cross-sections of the legs and the vertical height of the at least one gap.

Further, the described coupled inductor provides reduced fringing losses. Fringing losses are caused by magnetic flux that is not contained in a leg, for example in a shared leg, and that extends into the conducting material of the coils.

Further, the described coupled inductor can be provided with an improved magnetic coupling. Specifically, the coupling can be improved by selecting corresponding parameters such as the cross-section of the legs and/or the height of the one or more gaps.

Thus, compared to known coupled inductors, a coupled inductor with adjustable leakage inductance, with reduced fringing losses and with improved magnetic coupling is provided. A corresponding DC-DC converter, thus, can provide improved electric properties such as an increased power efficiency at reduced spatial dimensions. Thus, an improved yet further miniaturized coupled inductor is provided.

It is possible that the coupled inductor comprises a first vertical gap in the first center leg and a first vertical gap in the second center leg.

The provision of a vertical gap in each of the first and the second center leg provides the possibility of a symmetric construction with respect to the path of the magnetic flux. The vertical gaps in the two legs can have an equal height. However, it is also possible that the heights of the gaps in the two legs are different.

Then, additional degrees of freedom in adjusting the magnetic flux, specifically the path of the magnetic flux are provided. The spatial dimensions of the gaps can be adjusted such that the leakage inductance, the coupling or fringing losses can be adjusted. Further, it is possible to provide dimensions such that a combination of two or even three of these parameters are improved.

It is possible that the ratio between the height of the vertical gap per leg and the distance between the base and the top is between 0% and 80%. A ratio of 0.5% to 1.5%, e.g. 1.0%, is a preferred ratio.

A special effect of a ratio of this size is the substantially improved magnetic coupling compared to other ratios.

In this respect, the distance between the base and the top essentially equals the length of the legs in the vertical direction.

For the sake of simplicity, the vertical height of the gaps is included within the length of the legs as the gaps in the legs are regarded as parts of the legs although the gaps obviously do not contain any material of the legs.

The provision of the ratio between the height of the vertical gap and the distance between the base and the top, i.e. the ratio between the height of the vertical gap and the length of the legs provides a convenient parameter for optimizing the magnetic properties of the coupled inductor.

It is possible that the coupled inductor further comprises a vertical gap in the shared leg.

By providing a gap in the shared leg, another degree of freedom is provided to optimize the magnetic flux of the coupled inductor to improve the magnetic properties of the coupled inductor.

Specifically, it is possible to provide a preferred ratio of the height of the one or more gaps in the center legs and the heights of one or more gaps in the shared legs as a convenient parameter for optimizing the magnetic behavior of the coupled inductor.

The ratio between the sum of the heights of the gaps in the center legs and the heights of the gaps in the shared leg can be between 0.01% and 50%, e.g. 1%, 5%, 10%, 20%, or 40%.

Correspondingly, it is possible that the coupled inductor comprises one or more additional vertical gaps in the center legs.

Also, it is possible that the coupled inductor comprises one or more additional vertical gaps in the shared legs.

The provision of more than one gap per leg, i.e. per center leg or per shared leg, instead of a single, larger gap establishes a simple to realize possibility to reduce fringing losses.

As stated above, fringing losses are caused by magnetic flux leaving the provided flux conduction path and entering the conducting material of an adjacent coil.

By distributing the spatial area over a larger number of gaps the overall volume where flux enters the conducting material of the adjacent coil is reduced and the corresponding detrimental effects on the electric current in the corresponding coil are reduced.

The number of shared legs is not limited to one. Instead, the coupled inductor can comprise one or more additional shared legs. The shared legs are arranged between the center legs.

Also, the number of center legs is not limited to two. Instead, the number of center legs can be larger than two. In particular, the number of center legs can be 3, 4, 5, 6, 7, 8, 9, 10 or higher. However, it is preferred that the number of center legs is an even number, for example 2, 4, 6, 8, 10 or a higher even number. The provision of an even number of center legs provides the possibility of electrically connecting the corresponding coils wound around the center legs such that an interleaved switching is provided. A DC-DC converter with coils electrically connected in parallel provides the provision of an increased power capability of the converter. The provision of interleaved switching, i.e. a phase shift of 180° between each of a pair of coils can substantially contribute to reducing output voltage ripple.

Such multiphase interleaved applications can use a single power inductor in each phase to reduce output voltage ripple. The inductive coupling between the coils further reduces magnetic flux in the center leg, resulting in lower magnetic losses and an increased power efficiency. It is possible that each center leg and each shared leg has—at a specific vertical position between the base and the top—a cross-section. The corresponding cross-section at a specific vertical position, i.e. height, of a center leg can be smaller than the cross-section at the same height of a shared leg.

Specifically, it is possible that the cross-section of a center leg is smaller than the cross-section of each individual shared leg.

Thus, the shared legs have larger cross-sections than the center legs. However, the number of center legs can be larger than the number of shared legs. The provision of specific cross-sections of the shared legs and/or the center legs establishes an additional degree of freedom in designing the magnetic flux for improved magnetic properties.

Specifically, it is possible that the sum of the cross-sections of all center legs is larger than the sum of the cross-sections of all shared legs.

Further, it is possible that the sum of the cross-sections of all shared legs is larger than 0.5 times the sum of the cross-sections of all center legs.

Further, it is possible that the sum of the cross-sections of all shared legs is smaller than 1.0 times the sum of the cross-sections of all center legs.

In this respect, the provided criteria concerning the cross-sections can be possible for specific vertical positions, e.g. at the center height between the bottom and the top. However, it is possible that the corresponding criteria refer to each possible vertical position between the bottom and the top of the coupled inductor.

Further, it is possible that the sum of the heights of the vertical gaps of a shared leg is larger than the sum of the heights of the vertical gaps of the center legs.

Further, it is possible that the sum of the heights of the gaps of a shared leg is smaller than 20 times the height of a gap of a center leg.

With these criteria, improved magnetic flux conduction paths within the coupled inductor are provided such that the specific requirements (specifically adjusted leakage inductance, reduced fringing losses and improved coupling) are obtained.

Further, it is possible that the base and/or the top have one or more chamfered edges or notches.

Specifically, it is possible that the base and the top have a same footprint. More specifically, it is possible that the coupled inductor has—with respect to the legs and to the base and to the top—a symmetric construction with a symmetry plane arranged perpendicular to the Z axis and positioned in the center between the base and the top.

It is possible that the base and the top have an essentially rectangular footprint with essentially rounded corners. However, edges near two of the four corners can be chamfered. This applies when the coupled inductor comprises a single shared leg and two center legs.

When the coupled inductor comprises four center legs and a single shared leg then the coupled inductor can have an essentially rectangular or quadratic footprint. The footprint can be obtained by symmetrically arranging two coupled inductors with two center legs, each one next to another, such that areas with chamfered edges are arranged one next to another. The chamfered edges establish—in the combined coupled inductor—two notches arranged on opposite sides of the footprint.

It is possible that a shared leg protrudes—in a lateral direction—out of the area of the base.

It is possible that a vertical gap has a height between 0.001 mm and 10 mm, preferable 0.1 mm.

Specifically, a vertical gap in a center leg can be 0.14 mm. And a vertical gap in a shared leg can be 2.5 mm.

It is possible that the base and the top have an area in the transversal (x-y) plane between 18 mm² (e.g. 3 mm2×6 mm2) and 45000 mm² (e.g. 300 mm×150 mm). Preferred values could be in the range from 175 mm² to 700 mm², e.g. 375 mm².

It is possible that the coupled inductor has a height between 3 mm and 150 mm, preferably between 12 mm and 18 mm, e.g. 13.4 mm.

Further, it is possible that the coils comprise or consist of a material selected from copper (Cu), aluminum (Al), silver (Ag), eventually including impurities, or an alloy thereof.

The conductor of the coil may be a rectangular flat wire, a round wire or a litz-wire made of the above materials.

The conductor can be insulated with enameled insulation.

The ends of the coil may be utilized as the connector to a PCB.

The ends may coated with a conductive material which promotes solderability and may be coated with Sn or a suitable alloy of Sn, Ni, Cu and/or Ag.

Legs, base and top may consist of a ferromagnetic material, e.g. iron (Fe), nickel (Ni) or alloys containing iron or nickel. Or ferrite ceramics or metal powder composites, preferribly MnZn-ferrites. However, MnZn-ferrites are preferred.

It is possible that the coils have an interleaved coupling to one another.

Specifically, it is possible that each coil has a specifically dedicated coil such that an interleaved switching with a 180° phase shift is provided to reduce output voltage ripple.

Further, a DC-DC converter can comprise a coupled inductor as described above.

It is to be noted that for an improved coupling there may only be a single gap in the center leg which is sufficiently small.

### BRIEF DESCRIPTION OF THE DRAWINGS

Basic working principles of the coupled inductor and details of preferred embodiments are described with reference to the accompanying schematic figures.

In the figures:

FIG. 1 shows a side view of a coupled inductor CI.

FIG. 2 shows a top view onto a cross-section of the coupled inductor indicated in FIG. 1.

FIG. 3 shows a side view of a coupled inductor comprising four center legs.

FIG. 4 shows a top view onto a cross-section of the corresponding coupled inductor CI with four center legs.

FIG. 5 shows a side view of a coupled inductor with several gaps in the shared leg.

FIG. 6 shows the electrical configuration of the coils within the circuit environment of selected circuit elements of a DC-DC converter.

FIG. 7 shows a version of a coupled inductor with six center legs.

### DETAILED DESCRIPTION

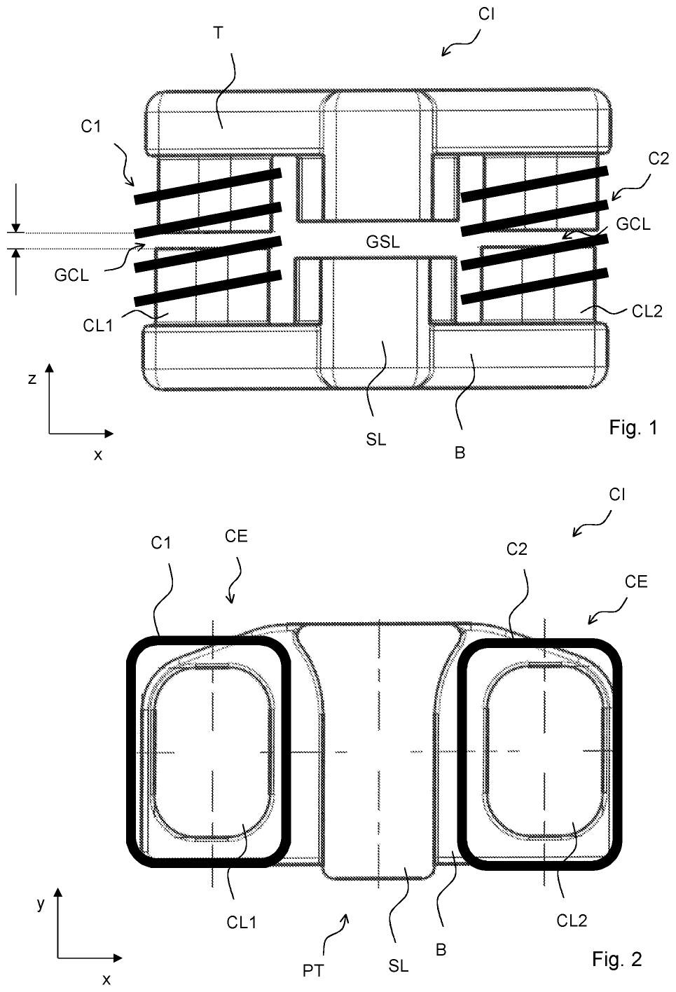

FIG. 1 shows a side view of a coupled inductor CI along the Y axis. The coupled inductor CI comprises a base B and a top T. The top T and base B are arranged one above another in the vertical direction (Z direction). In the vertical direction between the top T and the bottom B a first center leg CL1 and a second center leg CL2 are arranged. Further, between the top T and the bottom B a shared leg SL is arranged. The shared leg SL is arranged—with respect to a horizontal direction X—between the first center leg CL1 and the second center leg CL2. A first coil C1 is wound around the first center leg CL1. A second coil C2 is wound around the second center leg CL2. Thus, the first and the second center legs are essentially arranged at the center of the corresponding coil C1, C2. The shared leg SL is provided for conducting magnetic flux and the second center leg, respectively.

A gap GCL is provided in the first center leg CL1 and a further gap GCL is provided in the second center leg CL2. Further, a gap GSL is provided in the shared leg SL.

The provision of at least one gap in the center leg CL establishes a convenient parameter for optimizing the magnetic behavior of the coupled inductor. The provision of a gap in each of the center legs and the additional provision of a gap in the shared leg provides additional degrees of freedom that can be used for optimizing parameters such as the leakage inductance or the coupling or both.

FIG. 2 shows a view onto a cross-section parallel to the X-Y plane indicating the cross-sectional areas of the center legs CL1, CL2 and of the shared leg SL. A cross-section of the shared leg being larger than the cross-section of an individual center leg CL1 or CL2 but a cross-section of the center leg SL being smaller than the sum of the two cross-sections of both center legs is preferred for an optimized magnetic flux conduction path.

Further, the bottom B has an essentially rectangular footprint with two rounded corners and two chamfered edges CE. At the Y position of the chamfered edges CE the local extension of the shared leg SL along the horizontal direction S is increased.

At the opposite side the shared leg SL has a protrusion PT where the shared leg SL extends beyond the perimeter of the bottom B.

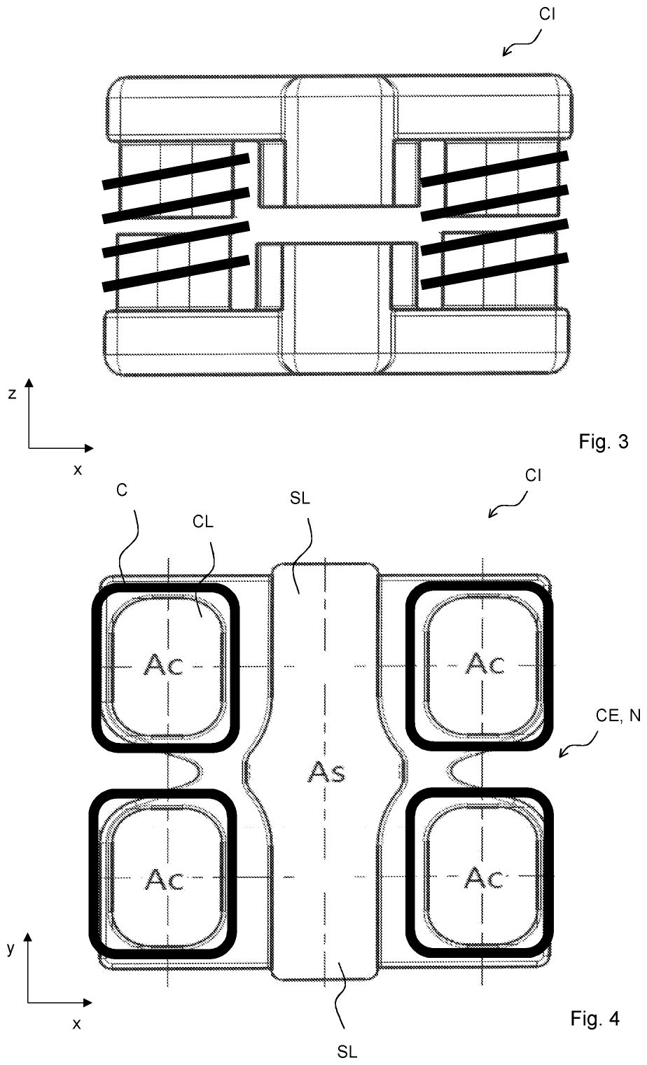

FIGS. 3 and 4 show side views and cross-sections of an embodiment with four center legs. Specifically FIG. 4 indicates that the embodiment with four center legs can be obtained by arranging two parts as shown in FIG. 2, one next to another, such that the areas of chamfered edges are arranged one next to another to establish notches extending into the bottom. The notch can have a width to depth ratio of 0.5 meaning that the notch is twice as deep as wide.

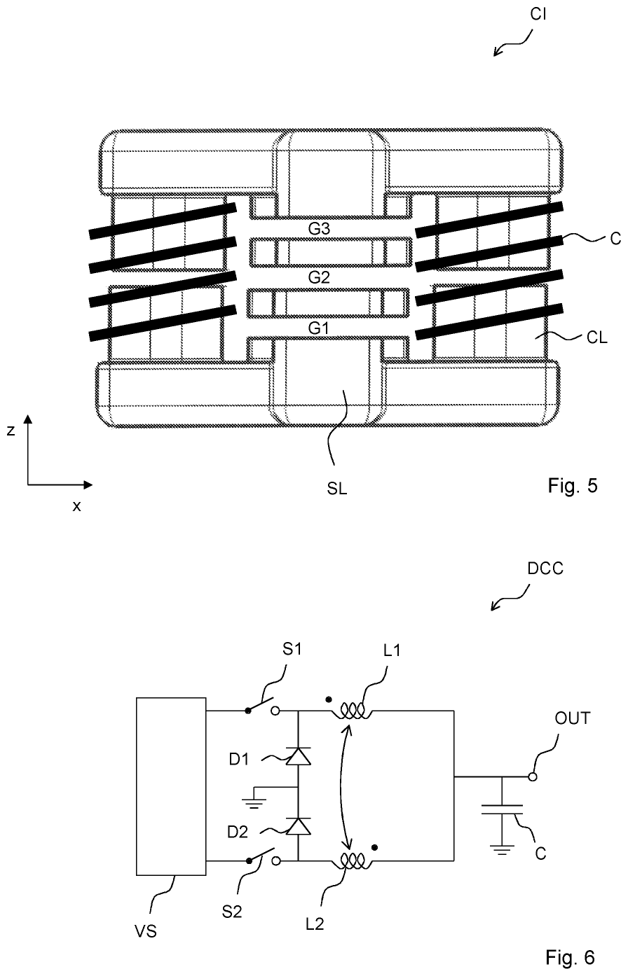

Further, FIG. 5 shows the possibility of dividing the gap of the shared leg into three sub-gaps G1, G2, G3. The provision of such a plurality of smaller gaps compared to a single larger gap reduces fringing losses caused by flux extending into the material of the coils C.

The provision of distributing a single, larger gap in the center legs into a plurality of smaller gaps in the center legs is also possible.

The number of gaps in the shared leg or in the center legs can be 1, 2, 3, 4, 5, 6, 7, 8, 9, 10 or larger.

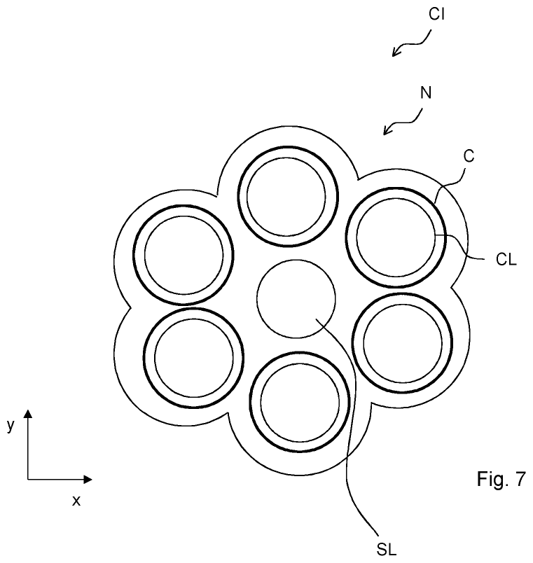

FIG. 6 shows circuit elements of an equivalent circuit diagram of a DC-DC converter DCC. A voltage source VS provides a certain electrical potential at two output ports. The output ports of the voltage source VS can be electrically connected to the two inductances L1, L2 realized by the two coils C of a coupled inductor as described above with two center legs via switches S1, S2. The two inductance elements are magnetically coupled via the material of the bottom and of the shared leg. Further, the converter DCC comprises two diodes D1, D2 electrically connected in series between the switches S1, S2. Further, the two inductance elements L1, L2 are electrically connected to an output port OUT where a selected secondary DC voltage level is provided and can be used by an external circuit environment. Further, an additional capacitance element C can be electrically connected to the output port OUT to further reduce voltage ripple.

FIG. 7 shows a coupled inductor comprising six center legs CL and six coils C. All six center legs share a single shared leg SL. Notches N can be provided at interface areas between base portions of adjacent center legs CL.

It is preferred that opposite center legs and their corresponding coils are electrically connected in an interleaved configuration such that three 180° interleaved coil pairs are obtained.

The coupled inductor and the DC-DC converter are not limited to details of embodiments described above or shown in the figures. Coupled inductors can comprise further electrical connections or ports and further magnetic flux conduction elements.

1. A coupled inductor, comprising
a base and a top,
a shared leg between the base and the top,
a first center leg between the base and the top and a second center leg between the base and the top,
a first vertical gap in the first center leg and/or a first gap in the second center leg,
a first coil and a second coil,
wherein
the first coil is wound around the first center leg,
the second coil is wound around the second center leg,
the shared leg is arranged between the center legs.

2. The coupled inductor according to claim 1, comprising a first vertical gap in the first center leg and a first vertical gap in the second center leg.

3. The coupled inductor according to claim 1, wherein the ratio between the height of the vertical gap and the distance between the base and the top is between 0% and 80%.

4. The coupled inductor according to claim 1, further comprising a vertical gap in the shared leg.

5. The coupled inductor according to claim 1, wherein the ratio between the sum of the heights of the vertical gaps in the center legs and the sum of the heights of the vertical gaps in the shared leg is between 0.01% and 50%.

6. The coupled inductor according to claim 1, comprising one or more additional vertical gaps in the center legs.

7. The coupled inductor according to claim 1, comprising one or more additional vertical gaps in the shared legs.

8. The coupled inductor according to claim 1, further comprising additional center legs with a corresponding additional coil.

9. The coupled inductor according to claim 1, further comprising one or more additional shared legs arranged between the center legs.

10. The coupled inductor according to claim 1, wherein the number of center legs is N with N=2, 4, 6, 8, 10 or a higher even number.

11. The coupled inductor according to claim 1, wherein
each center leg and shared leg has—at a specific vertical position between the base and the top a cross section and
the cross section of a center leg is smaller than the cross section of each shared leg.

12. The coupled inductor according to the previous claim 11, wherein
the sum of the cross sections of all center legs is larger than the sum of the cross sections of all shared legs.

13. The coupled inductor according to claim 12, wherein
the sum of the cross sections of all shared legs is larger than 0.5 times the sum of the cross sections of all center legs.

14. The coupled inductor according to claim 1, wherein the sum of the heights of the vertical gaps of a shared leg is larger than the sum of the heights of the vertical gaps of the center legs.

15. The coupled inductor according to claim 1, wherein the sum of the heights of the gaps of a shared leg is smaller than 20 times the height of a gap of a center leg.

16. The coupled inductor according to claim 1, wherein the base and/or the top have one or more chamfered edges or notches.

17. The coupled inductor according to claim 1, wherein a shared leg protrudes—in a lateral direction—out of the area of the base.

18. The coupled inductor according to claim 1, wherein a vertical gap has a height between 0.001 mm² and 10 mm.

19. The coupled inductor according to claim 1, wherein the base and the top has an area between 18 and 45000 mm².

20. The coupled inductor according to claim 1, having a height between 3 and 150 mm.

21. The coupled inductor according to claim 1, wherein the coils comprise or consist of a material selected from Cu, Al, Ag and an alloy thereof.

22. The coupled inductor according to claim 1, wherein the legs comprise or consist of a material selected from Fe, Ni, alloys containing Fe or Ni, ferrite ceramics, metal powder composites and MnZn-ferrites.

23. The coupled inductor according to claim 1, wherein the coils have an interleaved coupling to one another.

24. A DC-DC converter comprising a coupled inductor according to claim 1.
